(19) United States
(12) Patent Application Publication
(10) Pub. No.: US 2013/0286819 A1
(43) Pub. Date: Oct. 31, 2013

(54) MULTIMODE APPARATUS AND COMMUNICATON METHOD THEREOF

(71) Applicant: Electronics and Telecommunications Research Institute, Daejeon (KR)

(72) Inventors: Eunkyung Kim, Daejeon (KR); Won-Ik Kim, Daejeon (KR); Sung Kyung Kim, Daejeon (KR); Sung Cheol Chang, Daejeon (KR); Seokki Kim, Gyeonggi-do (KR); Mi Young Yun, Daejeon (KR); Hyun Lee, Daejeon (KR); Chul Sik Yoon, Seoul (KR); Kwang Jae Lim, Daejeon (KR)

(21) Appl. No.: 13/786,829

(22) Filed: Mar. 6, 2013

(30) Foreign Application Priority Data
Mar. 6, 2012 (KR) 10-2012-0022941
Mar. 5, 2013 (KR) 10-2013-0023434

(51) Int. Cl. H04L 12/24

(52) U.S. Cl. CPC H04L 41/0654
USPC 370/225

(57) ABSTRACT

A multimode apparatus and a communication method thereof are disclosed. If the multimode apparatus is chosen to serve as a relay station due to a base station having a backhaul link problem, it sets up a first relay link with a first base station. Upon receiving a request for releasing the first relay link from the first base station even though the backhaul link is not restored, the multimode apparatus sets up a second relay link with a second base station, or configures and operates a standalone network or an independent network.

### CROSS-REFERENCE TO RELATED APPLICATION

This application claims priority to and the benefit of Korean Patent Application Nos. 10-2012-0022941 and 10-2003-0023434 filed in the Korean Intellectual Property Office on Mar. 6, 2012, and Mar. 5, 2013, respectively, the entire contents of which are incorporated herein by reference.

### BACKGROUND OF THE INVENTION

(a) Field of the Invention

The present invention relates to a multimode apparatus and a communication method thereof.

(b) Description of the Related Art

In the event of a disaster or calamity, important social infrastructure may be destroyed or damaged. Some of the important social infrastructure includes a variety of communication facilities such as wireless phones, phones, internet networks, etc. Destruction or damage of such communication facilities would increase social chaos following a disaster and make it difficult for society to recover from the disaster.

Therefore, it is crucial to provide high-reliability support for means to quickly recover or replace the communication facilities.

Particularly, if a base station playing an essential role for communication of mobile terminals is damaged, or cannot serve its usual functions due to damage to a power line, an out-of-service area may appear.

As such, it is necessary to provide means of delivering wireless communication service to an out-of-service area.

### SUMMARY OF THE INVENTION

The present invention has been made in an effort to provide a multimode apparatus which continues to provide wireless communication service even in the event of damage to a base station, and a communication method thereof.

An exemplary embodiment of the present invention provides a communication method of a multimode base station. The communication method of the multimode base station may include: choosing a base station having a backhaul link problem as a multimode base station serving as a relay station; setting up a first relay link with a first base station neighboring the multimode base station; and if the backhaul link is not restored, and a request for releasing the first relay link is received from the first base station, releasing the first relay link with the first base station, and setting up a second relay link with the second base station or configuring and operating a standalone network or an independent network.

The setting up of the first relay link may include: transmitting a multimode relay request message to the first base station; receiving a multimode relay response message from the first base station; and if the multimode relay response message indicates acceptance, starting setting up a relay link with the first base station.

The setting up of the first relay link may further include, if the multimode relay response message indicates rejection, setting up a relay link with a third base station.

The setting up of the first relay link may further include, if the multimode relay response message indicates rejection, configuring a standalone network or an independent network and delivering service to subordinate terminals.

The communication method of the multimode base station may further include, if the backhaul link is restored, releasing the first relay link and delivering service through the restored backhaul link.

The multimode relay request message may contain information indicating whether the multimode base station operates in a TTR mode or an STR mode.

Another exemplary embodiment of the present invention provides a communication method of a multimode terminal. The communication method of the multimode terminal may include: choosing the multimode terminal to serve as a relay station if a first base station has a backhaul link problem; setting up a first relay link with a second base station having no backhaul link problem; and upon receiving a request for releasing the first relay link from the second base station, releasing the first relay link with the second base station, and setting up a second relay link with a third base station or switching to the base station function.

The setting up of the first relay link may include: transmitting a multimode relay request message to the second base station; receiving a multimode relay response message from the second base station; and if the multimode relay response message indicates acceptance, starting setting up a relay link with the second base station.

The setting up of the first relay link may further include, if the multimode relay response message indicates rejection, setting up a relay link with a fourth base station.

The setting up of the first relay link may further include, if the multimode relay response message indicates rejection, switching to the base station function.

The releasing of the first relay link may include: transmitting a multimode release request message to the second base station; and receiving a multimode release response message from the second base station.

Still another exemplary embodiment of the present invention provides a multimode apparatus. The multimode apparatus may include: a radio frequency module; and a processor connected to the radio frequency module, wherein, if the multimode apparatus is chosen to serve as a relay station due to a base station having a backhaul link problem, the processor may control the multimode apparatus to set up a first relay link with a first base station, and upon receiving a request for releasing the first relay link from the first base station even though the backhaul link is not restored, the processor may control the multimode apparatus to set up a second relay link with a second base station or configure and operate a standalone network or an independent network.

When setting up the first relay link, the processor may control the multimode apparatus to transmit a multimode relay request message to the first base station and receive a multimode relay response message from the first base station, and if the multimode relay response message indicates acceptance, the processor may control the multimode apparatus to start setting up a relay link with the first base station.

If the multimode relay response message indicates rejection, the processor may control the multimode apparatus to set up a relay link with the third base station or configure a standalone network or an independent network.

The multimode apparatus may be a terminal, or a base station having a backhaul link problem.

According to an exemplary embodiment of the present invention, a multimode apparatus can continue to deliver communication service to subordinate terminals by configuring a temporary network in an out-of-service area.

Moreover, according to an exemplary embodiment of the present invention, it is possible to deliver multimode service that accurately and efficiently meets high-reliability requirements in a mobile wireless connection system.

### BRIEF DESCRIPTION OF THE DRAWINGS

FIG. 1 is a view of when a base station is chosen as a multimode apparatus if there is a problem with a backhaul link of the base station in a mobile communication system according to an exemplary embodiment of the present invention.

FIG. 2 is a view of when a terminal is chosen as a multimode apparatus if there is a problem with a backhaul link of a base station in a mobile communication system according to an exemplary embodiment of the present invention.

FIG. 3 is a view showing a method for a multimode base station 210 to set up, release, and modify a relay link according to an exemplary embodiment of the present invention.

FIG. 4 is a view showing a method for a multimode terminal 130′ to set up, release, and modify a relay link according to an exemplary embodiment of the present invention.

FIG. 5 is a view showing a multimode apparatus 500 according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Similar reference numerals designate similar elements throughout the specification.

In this specification, a terminal may designate a mobile terminal (MT), a mobile station (MS), an advanced mobile station (AMS), a high reliability mobile station (HR-MS), a subscriber station (SS), a portable subscriber station (PSS), an access terminal (AT), user equipment (UE), etc., and may include the entire or partial functions of the terminal, the MT, the HR-MS, the PSS, the AT, the UE, etc.

In this specification, a base station (BS) may designate an advanced base station (ABS), a high reliability base station (HR-BS), a nodeB, an evolved nodeB (eNodeB), an access point (AP), a radio access station (RAS), a base transceiver station (BTS), a mobile multihop relay-BS (MMR-BS), a relay station (RS), a high reliability base station (HR-BS), etc., and may include the entire or partial functions of the ABS, the nodeB, the eNodeB, the AP, the RAS, the BTS, the MMR-BS, the RS, the HR-RS, etc.

Now, a multimode apparatus and a method for driving the same according to an exemplary embodiment of the present invention will be described in detail.

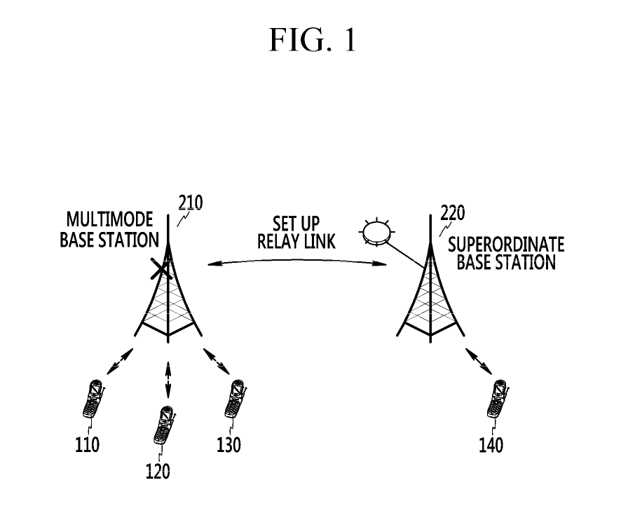

FIG. 1 is a view of when a base station is chosen as a multimode apparatus if there is a problem with a backhaul link of the base station in a mobile communication system according to an exemplary embodiment of the present invention.

As shown in FIG. 1, the mobile communication system according to the exemplary embodiment of the present invention includes base stations 210 and 220 and intra-cell terminals 110, 120, 130, and 140 serviced by the base stations 210 and 220. The terminals 110, 120, and 130 are located in the coverage of the base station 210, and the terminal 140 is located in the coverage of the base station 220.

In FIG. 1, the base station 210 has a backhaul link problem, and serves as a relay station using a relay link with the neighboring base station 220. Hereinafter, the base station 210 serving as a relay station due to a problem with the backhaul link is defined as a “multimode base station 210”. The neighboring base station 220 which sets up a relay link with the multimode base station 210 is hereinafter defined as an “superordinate base station 220”.

The intra-cell terminals 110, 120, and 130 may undergo a problem with mobile communication service due to the problem with the backhaul link of the base station 210; however, in this exemplary embodiment, the multimode base station 210 serves as a relay station and sets up a relay link with the superordinate base station 220. A temporary network is configured using such a relay link, so that the terminals 110, 120, and 130 can continue to get service.

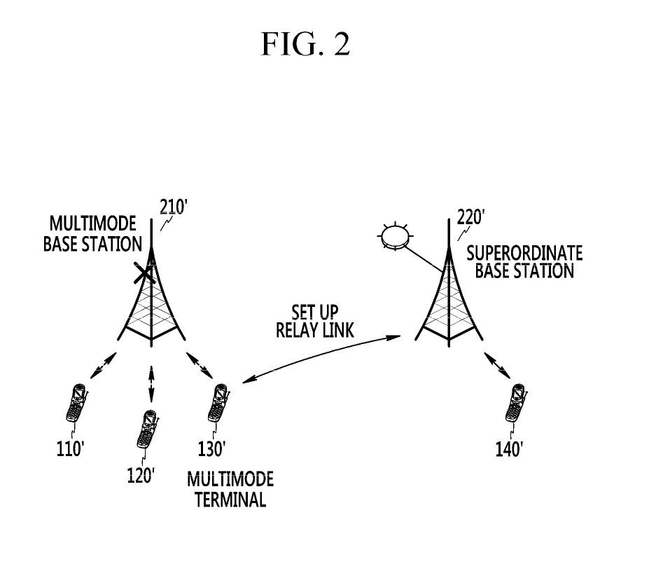

FIG. 2 is a view of when a terminal is chosen as a multimode apparatus if there is a problem with a backhaul link of a base station in a mobile communication system according to an exemplary embodiment of the present invention.

As shown in FIG. 2, the mobile communication system according to the exemplary embodiment of the present invention includes base stations 210′ and 220′ and intra-cell terminals 110′, 120′, 130′, and 140′ serviced by the base stations 210′ and 220′. The terminals 110′, 120′, and 130′ are located in the coverage of the base station 210′, and the terminal 140′ is located in the coverage of the base station 220′.

In FIG. 2, the base station 210′ has a problem with the backhaul link, and the terminals 110′, 120′, and 130′ located in the coverage of the base station 210′ undergo a problem with mobile communication service. In this exemplary embodiment of the present invention, however, a terminal serving as a relay station may be selected from among the terminals 110′, 120′, and 130′. As shown in FIG. 2, the terminal 130′ serves as a relay station and sets up a relay link with the neighboring base station 220′. The terminal 130′ serving as a relay station is defined as a “multimode terminal”. The neighboring base station 220′ which sets up a relay link with the multimode terminal 130′ is hereinafter defined as an “superordinate station 220′”.

The intra-cell terminals 110′, 120′, and 130′ may undergo a problem with mobile communication service due to the problem with the backhaul link of the base station 210′; however, in this exemplary embodiment, the multimode terminal 130′ serves as a relay station and sets up a relay link with the superordinate base station 220′. A temporary network is configured using such a relay link so that the terminals 110′, 120′, and 130′ can continue to get service.

While FIG. 1 illustrates the multimode base station 210 serving as a relay station, FIG. 2 illustrates the multimode terminal 130′ serving as a relay station. The multimode base station 210 and the multimode terminal 130′ are the same in that, in the event of a problem with a backhaul link, the multimode base station 210 serves as a relay station and the multimode terminal 130′ serves as a relay station, except that the multimode base station 210 is connected to the backbone network before a problem occurs in the backhaul link, whereas the multimode terminal 130′ is not directly connected to backbone network via backhaul link. Accordingly, the multimode base station 210 and the multimode terminal 130′ which both serve as a relay station are commonly defined as a “multimode apparatus”.

The multimode apparatus, i.e., the multimode base station 210 and the multimode terminal 130′, can operate in a TTR (time division transmit and receive) mode or an STR (simultaneous transmit and receive) mode.

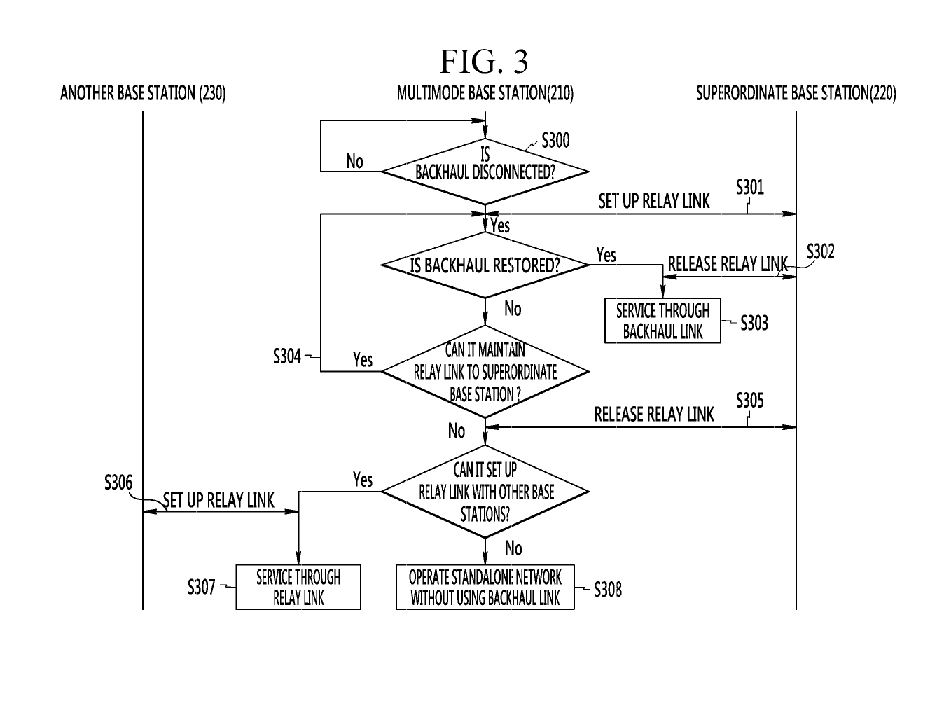

Next, a method for the multimode base station 210 to set up or release a relay link according to an exemplary embodiment of the present invention will be described in detail with reference to FIG. 3.

FIG. 3 is a view showing a method for a multimode base station 210 to set up, release, and modify a relay link according to an exemplary embodiment of the present invention.

First, the multimode base station 210 detects if there is a problem with a backhaul link (S300).

If there is a problem with a backhaul link, the multimode base station 210 sets up a relay link with a superordinate base station 220 (S301). The step S301 in which the multimode base station 210 sets up a relay link with the superordinate base station 220 will be described below in further detail.

To set up a relay link with the superordinate base station 220, the multimode base station 210 performs network entry and initialization for a relay link with the superordinate base station 220. A detailed description of a network entry and initialization method will be omitted because a person skilled in the art could easily understand the method.

The multimode base station 210 performs network entry to the superordinate base station 220, and then transmits a multimode relay request (MM-RS-REQ) message to the superordinate base station 220. The multimode relay request (MM-RS-REQ) message indicates whether the relay mode is the TTR mode or the STR mode. The multimode relay request (MM-RS-REQ) message may be transmitted to the multimode base station 210 from the superordinate base station 210.

Upon sending a relay setup request from the multimode base station 210 to the superordinate base station 220 through the multimode relay request (MM-RS-REQ) message, the superordinate base station 220 transmits a multimode relay response (MM-RS-RSP) message to the multimode base station 210. The multimode relay response (MM-RS-RSP) message may indicate acceptance or rejection. The multimode relay response (MM-RS-RSP) message may contain information telling the multimode base station 210 to try again after a given period of time.

Upon receiving the multimode relay response (MM-RS-RSP) message indicating acceptance from the superordinate base station 220, the multimode base station 210 starts setting up a relay link with the superordinate base station 220. Upon receiving a multimode relay response (MM-RS-RSP) message containing information telling the multimode base station 210 to try again from the superordinate base station 220, the multimode base station 210 re-transmits a multimode relay response (MM-RS-RSP) message after a given period of time.

If the multimode base station 210 receives a multimode relay response (MM-RS-RSP) message indicating rejection from the superordinate base station 220, or cannot try again after a given period of time, it may perform a procedure to set up a relay link with a base station 230 other than the superordinate base station 220. When the multimode base station 210 sets up a relay link with a base station 230 other than the multimode base station 210, it may perform initial network entry or handover to send a relay link setup request.

Alternatively, the multimode base station 210 can deliver service to the subordinate terminals 110, 120, and 130 by configuring a standalone network or an independent network, rather than by setting up a relay link with the base station 230.

If rejection is indicated in the multimode relay response (MM-RS-RSP) message, the superordinate base station 220 may add a reason for rejection. An example of the reason for rejection may include interference, etc.

Next, a method for the multimode base station 210 to release and modify a relay link with the superordinate base station 220 will be discussed.

The step S302 of releasing a set-up relay link is usually performed when the backhaul link of the multimode base station 210 is restored.

Moreover, the relay link can be released if interference occurs due to a surrounding base station or relay station or when there is a problem with the capacity of the superordinate base station 220. For convenience of explanation, the following description will be made assuming that the backhaul link of the multimode base station 210 is restored. However, the scope of the present invention is not limited thereto.

If the backhaul link of the multimode base station 210 is restored, a restoration notification is sent to the superordinate base station 220 through a backhaul interface. At this point, the superordinate base station 220 can handover again the terminals 110, 120, and 130 to the multimode base station 210. The multimode base station 210 may store MAC information of the subordinate terminals 110, 120, and 130 in advance when there is a problem with the backhaul link. If the multimode base station 210 has restored the backhaul link, the stored information may be used for the subordinate terminals to perform optimized network reentry to the multimode base station 210.

The multimode base station 210 whose backhaul link is restored transmits a multimode advertisement (MM-ADV) message to the subordinate terminals 110, 120, and 130. The multimode advertisement (MM-ADV) message contains an expected time of backhaul restoration. Upon receiving the multimode advertisement (MM-ADV) message, the subordinate terminals 110, 120, and 130 can return to the multimode base station 210 at the expected time. By doing so, the multimode base station 210 can resume service through the restored backhaul link (S303).

If the multimode base station 210 can maintain its relay link with the superordinate base station 220 even though the backhaul link of the multimode base station 210 is not restored, the multimode base station 210 can deliver service through the existing relay link (S304).

If the multimode base station 210 receives a relay link release request from the superordinate base station 220, or the backhaul link of the multimode base station 210 is not restored, the multimode base station 210 attempts to set up a relay link with another base station 230 having a backhaul link to the backbone network (S306). By doing so, the multimode base station 210 can deliver service through the relay link with the base station 230 (S307). The multimode base station 210 releases the relay link with the superordinate base station 220 before attempting to set up a relay link with the base station 230 (S305).

However, if the multimode base station 210 cannot set up a relay link with the base station 230, it may configure and operate a standalone network without using a backhaul link (S308).

If the multimode base station 210 receives a relay link release request from the superordinate base station 220, or the backhaul link of the multimode base station 210 is not restored, the multimode base station 210 may notify the superordinate base station 220 about non-restoration of the backhaul link so that it can maintain the relay link. Alternatively, if the multimode base station 210 receives a relay link release request from the superordinate base station 220, the multimode base station 210 may release the relay link with the superordinate base station 220 and set a relay link with the above-stated base station 230 to provide a seamless service. In this case, the multimode base station 210 can change (handover) the relay link to the base station 230 from the superordinate base station 220 rather than releasing/setting the relay link.

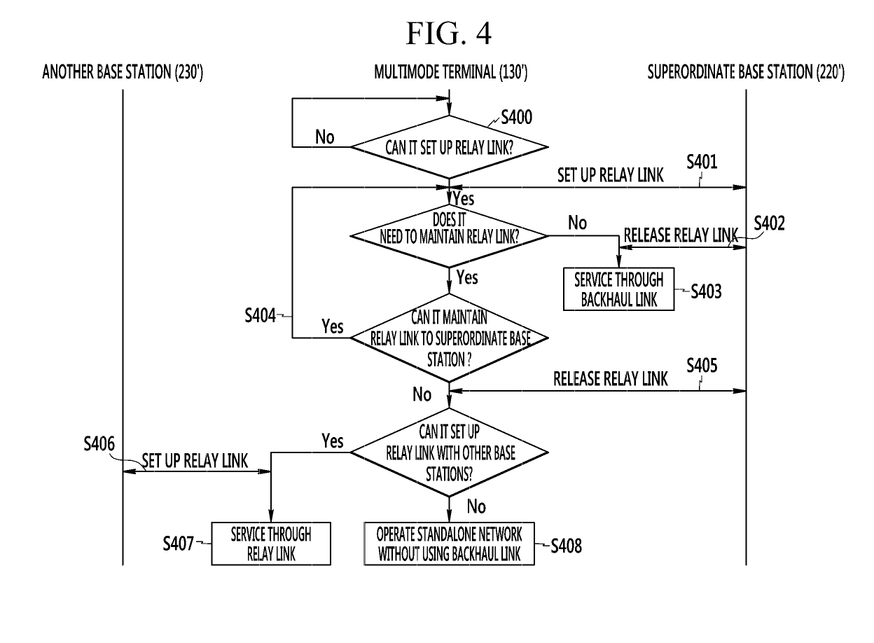

Next, a method for the multimode terminal 130′ to set up and release a relay link according to an exemplary embodiment of the present invention will be described in detail with reference to FIG. 4.

FIG. 4 is a view showing a method for a multimode terminal 130′ to set up, release, and modify a relay link according to an exemplary embodiment of the present invention.

If the multimode terminal 130′ itself can set up a relay link, it sets up a relay link with the superordinate base station 220′ (S400 and S401). The step S401 in which the multimode terminal 130′ sets up a relay link with the superordinate base station 220′ will be described below in further detail.

To set up a relay link with the superordinate base station 220′, the multimode terminal 130′ transmits a multimode relay request (MM-RS-REQ) message to the superordinate base station 220′. The multimode relay request (MM-RS-REQ) message indicates whether the relay mode is the TTR mode or the STR mode. The multimode relay request (MM-RS-REQ) message may be transmitted to the multimode terminal 130′ from the superordinate base station 220′.

Upon sending a relay setup request from the multimode terminal 130′ to the superordinate base station 220′ through the multimode relay request (MM-RS-REQ) message, the superordinate base station 220′ transmits a multimode relay response (MM-RS-REQ) message to the multimode terminal 130′. The multimode relay response (MM-RS-RSP) message may indicate acceptance or rejection. The multimode relay response (MM-RS-RSP) message may contain information telling the multimode terminal 130′ to try again after a given period of time.

Upon receiving multimode relay response (MM-RS-RSP) message indicating acceptance from the superordinate base station 220′, the multimode terminal 130′ starts setting up a relay link with the superordinate base station 220′. Upon receiving, from the superordinate base station 220′, a multimode relay response (MM-RS-RSP) message containing information telling the multimode terminal 130′ to try again, the multimode terminal 130′ re-transmits a multimode relay response (MM-RS-RSP) message after a given period of time.

If the multimode terminal 130′ receives a multimode relay response (MM-RS-RSP) message indicating rejection from the superordinate base station 220′, or cannot try again after a given period of time, it may perform to the procedure to set up a relay link with a base station 230′ other than the superordinate base station 220′. When the multimode terminal 130′ sets up a relay link with a base station 230′ other than the multimode terminal 130′, it may perform initial network connection or handover to send a relay link setup request.

Alternatively, the multimode terminal 130′ can deliver service to the subordinate terminals 110′ and 120′ by switching to the base station function and configuring a standalone network or an independent network, rather than by setting up a relay link with the base station 230′.

If rejection is indicated in the multimode relay response (MM-RS-RSP) message, the superordinate base station 220′ may add a reason for rejection. An example of the reason for rejection may include interference, etc.

The multimode terminal 130′ can maintain the terminal function even when it sets up a relay link with the superordinate base station 220′ and operates in the relay mode. In this case, the terminal mode of the multimode terminal 130′ operates as a subordinate terminal of the relay mode.

Next, a method for the multimode terminal 130′ to release and modify a relay link with the superordinate base station 220′ will be discussed.

The step S402 of releasing a relay link that set up for releasing the relay link is usually performed when the backhaul link of the base station 210′ is restored.

Moreover, the relay link can be released in case the multimode terminal 130′ is in motion or runs out of battery power. Besides, the relay link can be released if interference occurs due to a adjacent base station or relay station or when there is a problem with the capacity of the superordinate base station 220′. For convenience of explanation, the following description will be made assuming that the backhaul link of the base station 210′ of FIG. 2 is restored. However, the scope of the present invention is not limited thereto.

Before the multimode terminal 130′ releases the relay mode, it may be necessary to take a measure of switching the subordinate terminals 110′ and 120′ of the multimode terminal 130′ to another base station (or an infrastructure base station), in this case, the multimode terminal 130′ transmits a multimode advertisement (MM-ADV) message to the subordinate terminals 110′ and 120′

Meanwhile, the multimode terminal 130′ transmits a multimode release request (MM-RL-REQ) message to the superordinate base station 220′ via uplink, whereby a relay link release procedure begins and a handover of the terminal 110′ and 120′ is requested.

Upon receiving the multimode release request (MM-RL-REQ) message, the upper base station 220′ determines whether to release the multimode of the multimode terminal 130′. The superordinate base station 220′ transmits a multimode release response (MM-RL-RSP) message indicating acceptance or rejection of the multimode release request to the multimode terminal 130′ via downlink.

Upon receiving the multimode release response (MM-RL-RSP) message indicating acceptance, the multimode terminal 130′ starts releasing the relay mode immediately or after a predetermined period of time. Upon receiving the multimode release response (MM-RL-RSP) message indicating rejection, the multimode terminal 130′ maintains the relay mode operation, and may send the multimode release request (MM-RL-REQ) message again to the superordinate base station 220′ after a predetermined period of time.

Once the relay link between the multimode terminal 130′ and the superordinate base station 220′ has been released, and the base station 210′ has restored the backhaul link, the base station 210′ can deliver service to the subordinate terminals 110′, 120′, and 130′ through the backhaul link (S403).

On the other hand, if the multimode terminal 130′ needs to maintain the relay link because the backhaul link of the base station 210′ is not restored, and can maintain the relay link with the superordinate base station 220′, the multimode terminal can deliver service through a set-up relay link (S404).

If the multimode terminal 130′ receives a relay link release request from the superordinate base station 220′, or the backhaul link of the base station 210′ is not restored, the multimode terminal 130′ attempts to set up a relay link with another base station 230′ having a backhaul link (S406). By doing so, the multimode terminal 130′ can deliver service through the relay link with the base station 230′ (S407). The multimode terminal 130′ releases the relay link with the superordinate base station 220′ before attempting to set up a relay link with the base station 230′ (S405). In this case, the multimode terminal 130′ may change (handover) the relay link to the base station 230′ from the superordinate base station 220′ rather than releasing/setting a relay link.

However, if the multimode terminal 130′ cannot set up a relay link with the base station 230′, it may switch to the base station function, and configure and operate a standalone network or an independent network without using a backhaul link (S408).

If the multimode terminal 130′ receives a relay link release request from the superordinate base station 220′, or the backhaul link of the base station 210′ is not restored, the multimode terminal 130 may notify the superordinate base station 220′ about non-restoration of the backhaul link so that it can maintain the relay link.

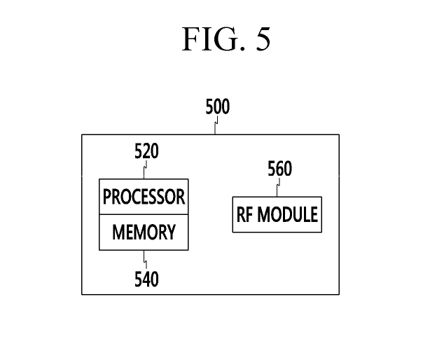

FIG. 5 is a view showing a multimode apparatus 500 according to an exemplary embodiment of the present invention. That is, the multimode apparatus 500 of FIG. 5 represents the multimode base station 210 or the multimode terminal 130′.

Referring to FIG. 5, the multimode apparatus 500 according to the exemplary embodiment of the present invention includes a processor 520, a memory 540, and a radio frequency (RF) module 560. The processor 520 may be configured to implement the above-explained procedure and methods. The memory 540 is connected to the processor 520, and stores various information regarding the operation of the processor 520. The RF module 560 is connected to the processor 520, and sends or receives a wireless signal. The multimode apparatus 500 may have a single antenna or multiple antennas.

According to an exemplary embodiment of the present invention, it is possible to deliver multimode service that accurately and efficiently meets high-reliability requirements in a mobile wireless connection system. Particularly, the service reliability of a multimode base station or multimode terminal can be enhanced, and efficient service can be delivered.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A communication method of a multimode base station, the method comprising:
choosing a base station having a backhaul link problem as a multimode base station serving as a relay station;
setting up a first relay link with a first base station neighboring the multimode base station; and
if the backhaul link is not restored, and a request for releasing the first relay link is received from the first base station, releasing the first relay link with the first base station, and setting up a second relay link with a second base station or configuring and operating a standalone network or an independent network.

2. The communication method of claim 1, wherein
the setting up of the first relay link comprises:
transmitting a multimode relay request message to the first base station;
receiving a multimode relay response message from the first base station; and
if the multimode relay response message indicates acceptance, starting setting up a relay link with the first base station.

3. The communication method of claim 2, wherein the setting up of the first relay link further comprises, if the multimode relay response message indicates rejection, setting up a relay link with a third base station.

4. The communication method of claim 2, wherein the setting up of the first relay link further comprises, if the multimode relay response message indicates rejection, configuring a standalone network or an independent network and delivering service to subordinate terminals.

5. The communication method of claim 1, further comprising, if the backhaul link is restored, releasing the first relay link and delivering service through the restored backhaul link.

6. The communication method of claim 2, wherein the multimode relay request message contains information indicating whether the multimode base station operates in a TTR mode or an STR mode.

7. A communication method of a multimode terminal, the method comprising:
choosing the multimode terminal to serve as a relay station if a first base station has a backhaul link problem;
setting up a first relay link with a second base station having no backhaul link problem; and
upon receiving a request for releasing the first relay link from the second base station, releasing the first relay link with the second base station, and setting up a second relay link with a third base station or switching to the base station function.

8. The communication method of claim 7, wherein
the setting up of the first relay link comprises:
transmitting a multimode relay request message to the second base station;
receiving a multimode relay response message from the second base station; and
if the multimode relay response message indicates acceptance, starting setting up a relay link with the second base station.

9. The communication method of claim 8, wherein the setting up of the first relay link further comprises, if the multimode relay response message indicates rejection, setting up a relay link with a fourth base station.

10. The communication method of claim 8, wherein the setting up of the first relay link further comprises, if the multimode relay response message indicates rejection, switching to the base station function.

11. The communication method of claim 7, wherein
the releasing of the first relay link comprises:
transmitting a multimode release request message to the second base station; and
receiving a multimode release response message from the second base station.

12. A multimode apparatus comprising:
a radio frequency module; and
a processor connected to the radio frequency module,
wherein, if the multimode apparatus is chosen to serve as a relay station due to a base station having a backhaul link problem, the processor controls the multimode apparatus to set up a first relay link with a first base station, and upon receiving a request for releasing the first relay link from the first base station even though the backhaul link is not restored, the processor controls the multimode apparatus to set up a second relay link with a second base station or configure and operate a standalone network or an independent network.

13. The multimode apparatus of claim 12, wherein, when setting up the first relay link, the processor controls the multimode apparatus to transmit a multimode relay request message to the first base station and receive a multimode relay response message from the first base station, and if the multimode relay response message indicates acceptance, the processor controls the multimode apparatus to start setting up a relay link with the first base station.

14. The multimode apparatus of claim 13, wherein, if the multimode relay response message indicates rejection, the processor controls the multimode apparatus to set up a relay link with the third base station or configure a standalone network or an independent network.

15. The multimode apparatus of claim 12, wherein the multimode apparatus is a terminal, or a base station having a backhaul link problem.
